(19) United States
(12) Patent Application Publication
(10) Pub. No.: US 2005/0140283 A1
(43) Pub. Date: Jun. 30, 2005

(54) Multilayer structure to form an active matrix display having single crystalline drivers over a transmissive substrate

(76) Inventors: Silvanus S Lau, San Diego, CA (US); James W. Mayer, Phoenix, AZ (US); Liang-Sun Hung, Webster, NY (US); Longru Zheng, Webster, NY (US)

Correspondence Address: GREER, BURNS & CRAIN, 300 S WACKER DR, 25TH FLOOR, CHICAGO, IL, 60606, US

(21) Appl. No.: 10/504,647

(22) PCT Filed: Feb. 13, 2003
(86) PCT No.: PCT/US03/04299

(30) Foreign Application Priority Data
Feb. 13, 2002 (US) 60357164

(51) Int. Cl. H01J 1/62

(52) U.S. Cl. 313/506

(57) ABSTRACT

A multilayer structure to form an active matrix display with single crystalline Si TFTs over a transmissive substrate. A light-emitting device is integrated with a single-crystalline Si layer over the light-transmitting substrate. The light generated by the light-emitting device is emitted from the substrate.

### TECHNICAL FIELD

The present invention relates to displays.

### BACKGROUND ART

Efficient flat-panel displays are highly desired in the art. For example, organic light-emitting devices (OLEDs) are of great interest due to their potential application in high efficiency, flat panel displays. OLEDs have been demonstrated as a light-emitting component in both passively and actively addressed displays. The passive matrix displays demonstrate the feasibility of OLEDs in applications, but encounter a fundamental barrier as the display size and pixel density increase. The current densities required to operate passively addressed displays rapidly rise as the time available to drive each pixel decreases with increasing display resolution. These high currents cause large voltage drops in the row lines of the passive array and create display driver issues that are not easily resolved.

In matrix addressing, as more rows are addressed, it becomes necessary to transfer charge to the pixel in a shorter period of time and to hold the charge on the pixel for a larger portion of the frame time. An active matrix display may be used to solve these issues. The active matrix display comprises a thin film transistor (TFT) in series with each pixel. These elements are incorporated primarily to create a sharp threshold to improve the multiplexibility of the display. They are capable of transferring the maximum charge to the pixel capacitance during the address time, and they do not allow significant leakage during the frame time.

Active-matrix OLEDs are conventionally fabricated using polysilicon (poly-Si) on glass. For example, FIG. 1 shows a multilayer structure 100 for an OLED-based display driven by poly-Si TFTs on glass. The structure 100 has a glass substrate 102 and a buffer layer 104. Thin film transistors 106 are formed on a polycrystalline Si thin film, which is deposited and crystallized over the glass substrate 102. The buffer layer 104 is inserted between the glass substrate 102 and an organic light-emitting device 110. An additional buffer layer 108 is deposited on the poly-Si TFTs 106. The organic light-emitting device 110 includes an ITO anode 112, an organic hole-transporting layer 114, an organic light-emitting layer 116, an organic electron-transporting layer 118 and an opaque metal cathode 120. Device operation is controlled by the poly-Si TFTs 106.

When an electrical potential difference (not shown) is applied between the anode 112 and the cathode 120 such that the anode is at a more positive electrical potential with respect to the cathode, electrons and holes are injected from the cathode and anode, respectively, and subsequently recombine with each other in the organic light-emitting layer 116. Energy is released as light, which is emitted through the hole-transport layer 114, the anode 112, the buffer layer 104, and the substrate 102, as indicated by the arrows shown in FIG. 1.

Two primary issues are typically encountered during the active matrix OLED display design. First, the electron mobility in poly-Si is substantially lower than that measured on single crystal silicon, and the mobility exhibits a strong dependence on grain size. Secondly, the poly-Si TFTs suffer from large variations in electrical properties due to the nature of the poly-Si crystal growth, making it difficult to generate a uniform current source at each pixel.

Several techniques are employed for crystallization of amorphous films, including low temperature solid phase crystallization, excimer laser annealing and metal seeding. Low temperature solid phase crystallization offers better performance, but at the expense of lower throughput. Excimer laser annealing can form poly-Si grains of excellent structural quality, but it demands tight control to avoid spatial nonuniformity and suffers from a very narrow process window. With metal seeding, the presence of residual metals in TFTs commonly results in high leakage currents.

Poly-Si TFTs with increased electron mobility up to 440 cm²/Vsec are generated at high process temperatures when a quartz substrate is used. They allow for small channel areas of 2 μm×2 μm for the high pixel densities that are needed in displays in camcorders, light valves in projectors, or document type displays with a pixel size of about 20-50 μm. However, there are certain shortcomings in these applications, such as: (1) a large area TFT is difficult to obtain; (2) substrates are costly due to the use of quartz, which is expensive; and (3) larger off-leakage current and more expensive fabrication techniques are required.

Considering the low electron mobility in poly-Si and process complexity to achieve high-quality large-grain poly-Si, it is highly desirable to fabricate particular displays such as OLEDs on single crystalline Si, which exhibits an important advantage of enabling on-chip data and scan drivers and allows for ultra-high pixel resolution (<10 microns). However, when Si is used as the substrate, the light emission through the substrate is blocked. It is therefore necessary that the electroluminescent (EL) light be able to exit through the top surface. These types of configurations for OLEDs, for example, are commonly known as surface-emitting OLEDs. Surface-emitting OLED structures have been fabricated with a transparent top electrode consisting of a thin buffer layer and a thicker overlying indium-tin oxide (ITO) film by sputtering deposition.

For example, FIG. 2 shows a multilayer structure 200 for an OLED-based surface-emitting display driven by single crystalline Si TFTs on Si. The structure 200 has an opaque Si substrate 202 and a buffer layer 204. Thin film transistors 206 are formed on the surface layer of the single crystalline Si wafer 202 for active matrix addressing. The buffer layer 204 is inserted between the single crystalline Si substrate 202 and an organic light-emitting device 210. An additional buffer layer 208 is deposited on the single crystalline Si TFTs 206. The organic light-emitting device 210 includes an anode 212, an organic hole-transporting layer 214, an organic light-emitting layer 216, an organic electron-transporting layer 218 and a semi-transparent cathode 220. Device operation is controlled by the single crystalline Si TFTs 206.

When an electrical potential difference (not shown) is applied between the anode 212 and the cathode 220 such that the anode is at a more positive electrical potential with respect to the cathode, electrons and holes are injected from the cathode and anode, respectively, and subsequently recombine with each other in the organic light-emitting layer 216. As an opaque Si wafer is employed as the substrate 202, light is emitted only from the top, semi-transparent cathode 220, as indicated by the arrows shown in FIG. 2.

G. Gu et al., “Transparent Organic Light Emitting Devices”, Appl. Phys. Lett. 68, 2606 (1996), discloses an OLED structure with a transparent top electrode consisting of a thin MgAg layer and a thicker overlying ITO film. However, when ITO was deposited using a conventional sputtering process, the resulting OLED was often leaky, indicative of inter-electrode shorts. Furthermore, the forward device current was substantially lower than that of a conventional device with a thermally evaporated thick MgAg cathode. A low sputtering power of 5 W for ITO was found necessary to produce functional OLEDs without excessive shorts. However, the sputtering rate (about 0.3 nm/min) was slow because of the low sputtering power used.

G. Parthasarathy et al., “A Metal-Free Cathode for Organic Semiconductor Devices” Appl. Phys. Lett. 72, 2138 (1998), and L. S. Hung et al., “Interface Engineering in Preparation of Organic Surface-Emitting Diodes”, Appl. Phys. Lett. 74, 3209 (1999), disclose a transparent top electrode structure employing a thin film of copper phthalocyanine (CuPc) instead of MgAg, overlaid by a sputter-deposited ITO film. The CuPc apparently acts as a buffer in reducing the shorting problem caused by the ITO sputtering process. However, the CuPc layer forms an electron-injection barrier with an Alq layer, resulting in increased electron-hole recombination in the non-emissive CuPc layer, and thus a substantial reduction in EL efficiency. Incorporation of Li at the CuPc/Alq interface was necessary to reduce the injection barrier at the interface and recover the device efficiency.

Furthermore, since OLEDs are extremely sensitive to radiation, the use of a sputter-deposited ITO film to form a transparent top electrode not only increases the complexity of electrode preparation, but also introduces substantial radiation damage to OLEDs, thus resulting in device shorts and severe degradation of device performance. The use of a buffer layer has not been sufficient to completely resolve the problems, and also makes the process more difficult for manufacturing.

### DISCLOSURE OF THE INVENTION

The present invention provides a multilayer structure to form an active-matrix display with single crystalline TFTs over a light-transmissive substrate. In the multilayer structure, a single crystalline Si layer is bonded to a light-transmissive substrate to form a single crystalline Si-coated substrate. At least one light-emitting device is formed over the coated substrate. A method of forming a multilayer structure to form an active-matrix display is also provided.

### BRIEF DESCRIPTION OF THE DRAWINGS

FIG. 1 is a schematic diagram of a multilayer structure for an OLED-based display driven by poly-Si TFTs on glass;

FIG. 2 is a schematic diagram of a multilayer structure for an OLED-based surface-emitting display driven by single crystalline Si TFTs on Si;

FIG. 3 is a schematic diagram of a multilayer structure to form an OLED-based display with single crystalline Si TFTs over a transmissive substrate according to an embodiment of the invention;

FIG. 4 is a schematic diagram of a multilayer structure to form a LCD-based display with single crystalline Si TFTs over a transmissive substrate according to another embodiment of the invention;

FIG. 5 is a graph indicating good crystal quality of the Si thin film on glass by ion-channeling analysis; and

FIGS. 6A and 6B are graphs showing electrical and optical characteristics, respectively, of a sample OLED grown on a single crystalline Si/glass substrate.

### BEST MODE OF CARRYING OUT THE INVENTION

The present invention provides, among other things, a multilayer structure to form an active matrix display with single crystalline TFTs over a light-transmissive substrate. According to a preferred embodiment of the present invention, at least one light-emitting device is formed with a single-crystalline Si layer over a light-transmissive substrate. The single crystalline Si layer is bonded to the light-transmissive substrate to form a single crystalline Si-coated substrate, and at least one light-emitting device is formed over the coated substrate. Methods for forming a multilayer structure for an active matrix display are also provided.

By integrating the light-emitting device with single crystalline Si over the light-transmissive substrate, light generated in the light-emitting device can be emitted through the substrate. Accordingly, conventional structures, such as conventional OLED structures, and processing sequences in manufacturing may be utilized, while obtaining the benefit of the use of Si. The new multilayer structures provide high electron mobilities, and thus allow for small channel areas for high pixel densities. This technique preferably also avoids an often difficult processing step of low temperature crystallization and grain growth in the fabrication of polycrystalline Si TFTs. This invention preferably may be used for displays having various light-emitting devices, such as organic light-emitting devices (OLEDs), polymer light-emitting devices (PLEDs), and liquid crystal devices (LCDs).

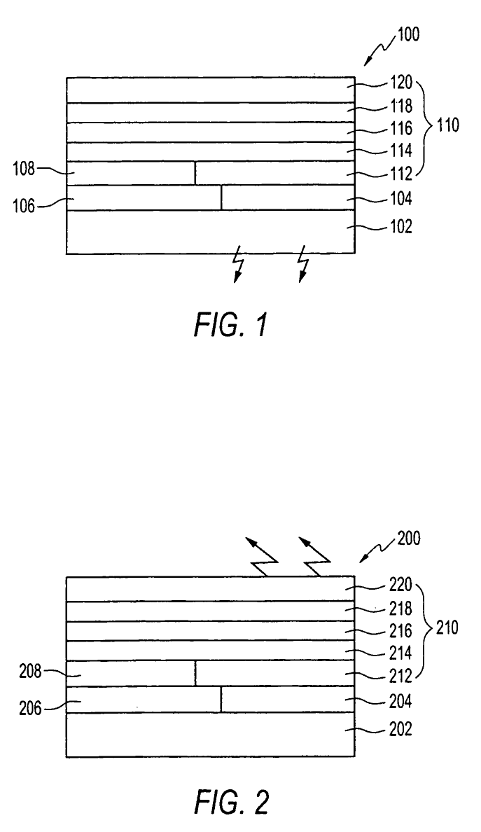

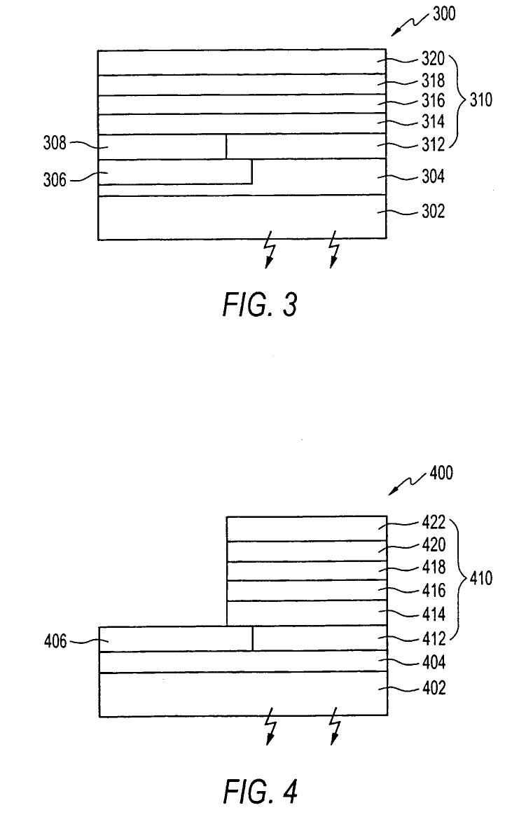

Referring now to the drawings, an exemplary multilayer structure 300 according to an embodiment of the present invention is shown in FIG. 3 to form an OLED-based display with single crystalline TFTs over a light-transmissive substrate. FIGS. 1-4 are necessarily of a schematic nature, since the thicknesses of the individual layers are too thin, and thickness differences of the various elements are too great to permit depiction to scale or to permit convenient proportionate scaling. The structure 300 has a light-transmissive substrate 302 and preferably a buffer layer 304. A thin film of single crystalline Si 306 is bonded over (as the multilayer structure 300 is oriented in FIG. 3) the light-transmissive substrate 302 to form a single crystalline Si-coated substrate, allowing for fabrication of single crystalline TFTs on the substrate. Preferably, the single crystalline Si film 306 is positioned over a portion of the substrate 302, and not over the entire substrate. The buffer layer 304 preferably is inserted between the light-transmissive substrate 302 and an organic light-emitting device 310. Some of the buffer layer 304 may be disposed between the substrate 302 and the single crystalline Si layer 306, but the single crystalline Si layer may alternatively be bonded directly to the substrate. An additional buffer layer 308 preferably is deposited on the single crystalline Si layer 306. The organic light-emitting device 310 preferably includes a transmissive hole injector 312, a hole-transport layer 314, an organic light-emitting layer 316, an electron-transport layer 318 and a metal electron injector 320.

When an electrical potential difference (not shown) is applied between the hole injector 312 and the electron injector 320 such that the hole injector is at a more positive electrical potential with respect to the electron injector, electrons and holes are injected from the electron injector and hole injector, respectively, and subsequently recombine with each other in the organic-light-emitting layer 316. Operation of a device having the multistructure 300 is controlled by TFTs made of single crystalline Si. Energy is released as light, which is emitted through the hole-transport layer 314, the hole injector 312, the buffer layer 304 and the light-transmissive substrate 302, as indicated by the arrows shown in FIG. 3.

The light-transmissive substrate 302 is an electrically insulated material. The material can be selected from among at least glass and plastic foil. The buffer layers 304, 308 are electrically insulated and light transmissive, and are used for planization and isolation. The materials of the buffer layers 304, 308 can be selected from among at least oxides and nitrides. Suitable oxides include at least Si-dioxide and non-conductive metal oxides.

The single crystalline Si thin film 306 is bonded over the substrate 302. In accordance with a preferred embodiment, the thickness of the Si layer is preferably but not necessarily from 5 to 100 nm, and most preferably 10 to 30 nm. When the thickness is below 5 nm, it may not be sufficient for fabricating thin film transistors. When the thickness is above 100 nm, it may result in high operation voltages of TFTs.

The growth of a single crystalline Si thin film on glass can be accomplished by combining wafer bonding with various techniques, such as etch-stop, localized polishing, and ion-cutting. In the ion-cut process both implantation of hydrogen ions and wafer bonding are employed. For example, a Si wafer is implanted with hydrogen ions, followed by bonding of the implanted side of the wafer to the light-transmissive substrate 302, preferably at or about room temperature or slightly elevated temperature, and then heated to a relatively low temperature, such as between 200° C. and 300° C. to strengthen bonding. After bonding, the substrate is further heated to a relatively higher temperature, for example, between 400° C. to 600° C., to delaminate the implanted single crystalline Si layer 306, and form the single crystalline Si-coated substrate. The hydrogen implantation to a Si wafer along with subsequent thermal treatment enables a high uniformity of the top silicon layer thickness to be obtained, whereas the wafer bonding preferably transfers the silicon layer onto different kind substrates with its original crystalline quality substantially unchanged. Hydrogen implantation induced layer splitting is one preferred method for the formation of an integrated structure of light-emitting devices on single crystalline Si drivers on glass.

The hole injector 312 (anode) is a conductive and light-transmissive layer. This layer can be selected from among at least the group of metal oxides. Suitable metal oxides include at least indium-tin oxide, aluminum-doped zinc oxide, tin oxide, magnesium-indium oxide, nickel-tungsten oxide, and cadmium-tin oxide.

The hole-transport layer 314 contains at least one hole transporting aromatic tertiary amine. The amine material is a compound containing at least one trivalent nitrogen atom that is bonded only to carbon atoms, at least one of which is a member of an aromatic ring. For example, in one form the aromatic tertiary amine may be an arylamine, such as a monarylamine, diarylamine, triarylamine, or a polymeric arylamine. Exemplary monomeric triarylamines are illustrated by Klupfel et al. in U.S. Pat. No. 3,180,730. Other suitable triarylamines substituted with vinyl or vinyl radicals and/or containing at least one active hydrogen containing group are disclosed by Brantley et al. in U.S. Pat. Nos. 3,567,450 and 3,658,520.

The light-emitting layer 316 of the organic light-emitting device 310 includes a luminescent or fluorescent material, where electroluminescence is produced as a result of electron-hole pair recombination in this region. In the simplest construction, the luminescent layer 316 comprises a single component, which is a pure material with a high fluorescent efficiency. A well-known material is tris (8-quinolinato) aluminum (Alq), which produces excellent green electroluminescence. A preferred embodiment of the luminescent layer 316 comprises a multi-component material consisting of a host material doped with one or more components of fluorescent dyes. Using this method, highly efficient electroluminescent (EL) devices can be constructed. Simultaneously, the color of the EL devices can be tuned by using fluorescent dyes of different emission wavelengths in a common host material. An exemplary dopant scheme is described in detail for EL devices using Alq as the host material in Tang et al., U.S. Pat. No. 4,769,292.

Preferred materials for use in forming the electron-transporting layer 318 of the organic light-emitting device 310 include metal chelated oxinoid compounds, including chelates of oxine itself (also commonly referred to as 8-quinolinol or 8-hydroxyquinoline). Such compounds exhibit both high levels of performance and are readily fabricated in the form of thin layers.

The electron injector 320 (cathode) can be formed by depositing a metal or a metal alloy layer having a work function less than 4 eV on the organic electron-transport layer 318. The electron injector 320 can also be formed by depositing a bilayer cathode on the electron-transport layer. The bilayer cathode preferably includes a thin inner layer of metal fluorides or oxides and a thick Al outer layer. The metal fluoride layers can be selected from among alkali fluorides or alkaline earth fluorides. The metal oxide layers can be selected from alkali oxides or alkaline earth oxides. The thickness of the fluoride or oxide layer preferably is in the range of 0.1 to 2.0 nm, and the thickness of the Al layer preferably is in the range of 30 to 200 nm.

FIG. 4 shows an exemplary multilayer structure 400 to form an LCD-based display with single crystalline TFTs over a transmissive substrate. The structure 400 has a light-transmissive substrate 402 and a buffer layer 404. A thin film of single crystalline Si 406 is bound over (as the multilayer structure 400 is oriented in FIG. 4) the light-transmissive substrate 402 to form a single crystalline Si-coated substrate, allowing fabrication of single crystalline TFTs. The buffer layer 404 is preferably inserted between the light-transmissive substrate 302 and a liquid crystal device 410. The liquid crystal device 410 preferably includes a rear polarizer layer 412, a bilayer 414 having an ITO electrode and a polymer alignment layer with the electrode disposed next to the rear polarizer, a layer of liquid crystal molecules 416, another bilayer 418 having a polymer alignment layer and an ITO electrode with the polymer layer disposed next to the liquid crystal molecules layer 416, a front polarizer layer 420, and a backlight source 422. The function and requirement of the substrate 402, the buffer layer 404 and the single crystalline Si film 406 are identical to those of the substrate 302, the buffer layer 304 and the single crystalline film 306 in FIG. 3, respectively, while the liquid crystal device cell 410 replaces the OLED 310.

With no voltage applied (the OFF state), light from the backlight source 422 is polarized after passing the front polarizer 420. The polarized light in the liquid crystal molecules layer 416 follows the direction of the twisted liquid crystal molecules and undergoes a 90° or 270° rotation as it exits the cell. The polarized light is absorbed nearly completely by the rear polarizer 412 when the two polarizers are laminated to the outside surfaces of the device 410 with the front polarization identical to the rear polarization direction. With an applied voltage (the ON state), the liquid crystal molecules are oriented parallel to the electric field. In this case, polarized light entering the liquid crystal molecules layer 416 is not rotated and passes through the rear polarizer 412 unchanged. Thus, the ON state is “bright” while the OFF state is “black”. The operation of the LCD device 40 is controlled by the single crystalline TFTs in the single crystalline Si layer 406. The light passes through the light-transmissive substrate 402, as indicated in the arrows shown in FIG. 4.

A description of an exemplary method for forming an embodiment of the multilayer structure 300, 400 to form an active-matrix display, described herein by example for an OLED-based display, follows. Artisans will recognize the general applicability and scalability of the invention as a routine extension of the described exemplary method. To transfer the single crystalline Si 306, 406 to the light-transmissive substrate 302, 402 and form the coated substrate, implantation of hydrogen ions into a Si wafer was carried out at 50 keV to a dose of 7×10¹⁶/cm². Both the implanted Si wafer and a piece of Corning 1737 glass were cleaned with organic solvents and rinsed in deionized water, and subsequently treated with oxygen plasma at 110 W for 30 s. The two specimens were bonded directly face to face at room temperature or at slightly elevated temperature after standard RCA cleaning of the implanted wafer. The bonded pair was then heated at 300° C. for 12 h to strengthen bonding, and then heated at 400° C. for 20 min, which led to the formation of H-filled gas bubbles in the implanted wafer. These gas bubbles grow in size via Ostwald ripening, and ultimately provide the force to induce cleavage in the implanted Si wafer. This process enables the transfer of a thin Si film with an average thickness of 540 nm from the donor wafer to the receptor glass. The thickness of the transferred Si layer was further reduced to 140 nm by dry etching in a mixture of CF₄ and O₂. Both ion channeling and cross-section TEM were employed to examine the crystalline quality and structural defects of the Si thin film on glass.

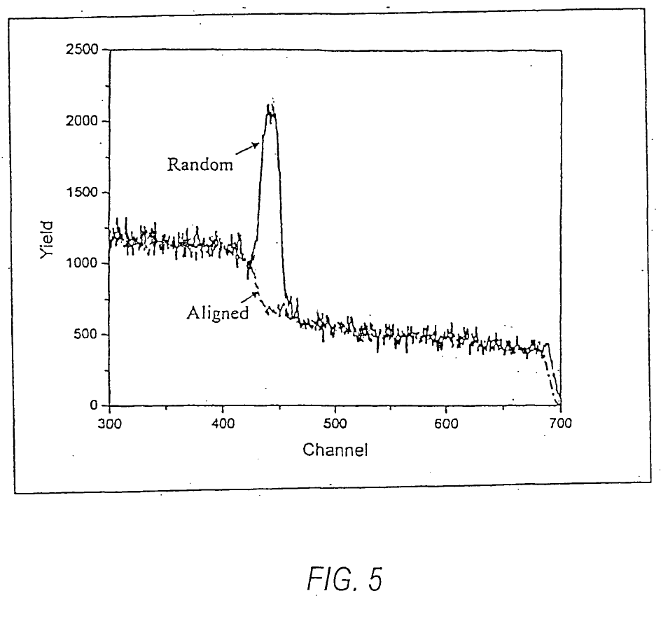

FIG. 5 shows backscattering spectra with He ions at both a random and a [100]-oriented incidence. No interactions between glass and Si were revealed, and the Si peak virtually disappeared at the [100]-oriented incidence, as compared to the random spectrum, indicating excellent crystal quality. The Si atoms were well aligned, and no structural defects were observed. The crystalline structure of the Si phase appeared to extend up to the Si-glass boundary, and the boundary appeared clean. These results indicate a good crystalline quality of Si, which is a prerequisite for the preparation of single crystalline TFTs on glass.

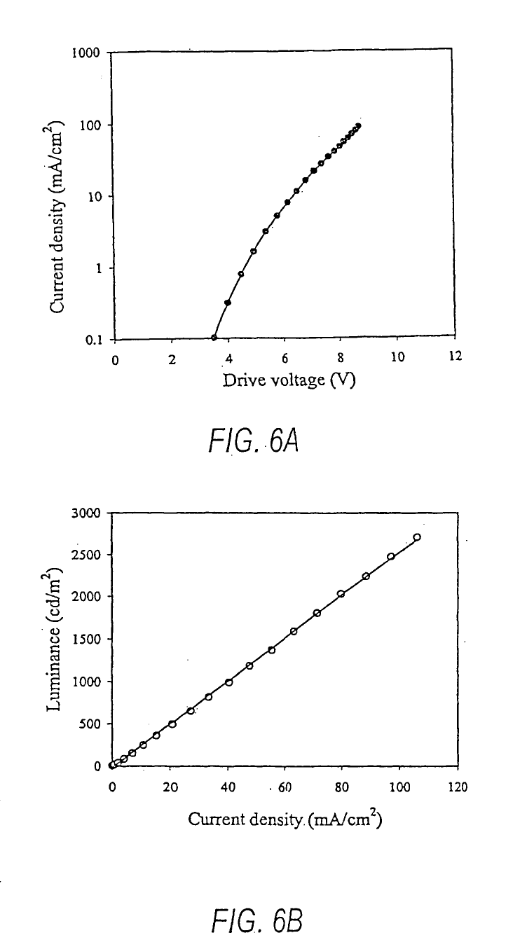

To prepare the organic light-emitting device 310 on the single crystalline Si-coated glass to form the multilayer structure, an organic light-emitting structure was constructed in the following exemplary manner. A patterned ITO hole injector (anode) was deposited through a shadow mask by sputter-deposition and then treated by oxygen plasma to enhance hole injection. 75 nm thick NPB (4,4′-bis-[N-(1-naphthyl)-N-phenylamino]-bi-phenyl) hole-transporting layer was deposited on the ITO-glass by conventional thermal vapor deposition. A 75 nm thick Alq (tris (8-quinolinolato-N1, 08)-aluminum) electron-transporting and light-emitting layer was then deposited on the NPB layer by conventional thermal vapor deposition. Next, a MgAg (magnesium: silver at a ratio of 10:1 by volume) electron injector (cathode) was deposited on the Alq layer by conventional thermal vapor deposition from two sources (Mg & Ag) to a thickness of about 200 nm. The current-drive voltage and the luminance-current characteristics are plotted in FIGS. 6A and 6B, which indicate that the OLED appeared to exhibit good electrical and optical characteristics.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A multilayer structure comprising:
a light-transmissive substrate;
a single crystalline Si layer bonded to said light-transmissive substrate to form a single crystalline Si-coated substrate;
at least one light-emitting device formed over the single crystalline Si-coated substrate.

2. The multilayer structure of claim 1 wherein said light-transmissive substrate comprises a material selected from the group consisting of glass and plastic foils.

3. The multilayer structure of claim 1 wherein said single crystalline Si layer is bonded to said light-transmissive substrate by being transferred from a Si wafer to said light-transmissive substrate using a method comprising at least one of etch-stopping, localized polishing, and ion-cutting.

4. The multilayer structure of claim 1 wherein said single crystalline Si-coated substrate of said single crystalline Si layer is between 5 and 100 nm in thickness.

5. The multilayer structure of claim 1 further comprising:
a buffer layer disposed between said light-transmissive substrate and said light-emitting device.

6. The multilayer structure of claim 5 wherein said buffer layer comprises an electrically insulated and light-transmissive material.

7. The multilayer structure of claim 5 wherein said buffer layer comprises a material selected from the group consisting of oxides and nitrides.

8. The multilayer structure of claim 1 wherein at least one thin-film transistor (TFT) is formed in said single-crystalline Si layer.

9. The multilayer structure of claim 1 wherein said at least one light-emitting device comprises an organic light-emitting device.

10. The multilayer structure of claim 9 wherein said at least one organic light-emitting device comprises:
a light-transmissive hole injector;
an organic hole-transporting layer formed over said hole injector;
an organic light-emitting layer formed over said hole-transporting layer;
an organic electron-transporting layer formed over said light-emitting layer;
an opaque metal electron injector formed over said organic electron-transporting layer.

11. The multilayer structure of claim 10 wherein said hole injector comprises a metal oxide material.

12. The multilayer structure of claim 10 wherein said hole injector comprises a material selected from the group consisting of indium-tin oxide, aluminum-doped zinc oxide, tin oxide, magnesium-indium oxide, nickel-tungsten oxide, and cadmium-tin oxide.

13. The multilayer structure of claim 10 wherein said hole injector comprises an anode, and wherein said electron injector comprises a cathode.

14. The multilayer structure of claim 10 wherein said organic hole-transporting layer comprises a material including hole-transporting aromatic tertiary amine molecules.

15. The multilayer structure of claim 10 wherein said organic light-emitting layer is formed of a light-emitting host material comprising a metal chelated oxinoid compound.

16. The multilayer structure of claim 10 wherein said organic light-emitting layer further includes at least one dye capable of emitting light when dispersed in a light-emitting host material.

17. The multilayer structure of claim 10 wherein said electron-transporting layer is formed of a material selected from the group consisting of metal chelated oxinoid compounds.

18. The multilayer structure of claim 10 wherein said electron injector electrode material is selected to have a work function less than 4 eV.

19. The multilayer structure of claim 10 wherein said electron injector comprises a thin metal fluoride layer and a thin Al outer layer.

20. The multilayer structure of claim 1 wherein said at least one light-emitting device comprises a polymer light-emitting device (PLED).

21. The multilayer structure of claim 1 wherein said at least one light-emitting device comprises a liquid crystal device (LCD).

22. A multilayer structure comprising:
a light-transmissive substrate;
a single crystalline Si layer bonded on the substrate to form a single crystalline Si-coated substrate;
at least one liquid crystal device (LCD) formed over the single crystalline Si-coated substrate.

23. The multilayer structure of claim 22 wherein said light-transmissive substrate is selected from the group of glass and plastic foils.

24. The multilayer structure of claim 22 wherein said single crystalline Si layer is transferred from a Si wafer by a technique selected from the group consisting of etch-stop, localized polishing, and implantation of hydrogen ions.

25. The multilayer structure of claim 22 wherein the thickness of said Si layer on said single crystalline Si-coated substrate is between 5 and 100 nm.

26. The multilayer structure of claim 22 further comprising:
a buffer layer disposed between said light-transmissive substrate and said at least one liquid crystal device.

27. The multilayer structure of claim 22 wherein said single crystalline Si layer comprises at least one thin-film transistor (TFT) formed in said single-crystalline Si layer.

28. The multilayer structure of claim 22 wherein said at least one liquid crystal device comprises:
a rear polarizer;
a light-transmissive electrode;
a polymer alignment layer;
a layer of liquid crystal molecules;
another polymer alignment layer;
another light-transmissive electrode;
a front polarizer; and
a backlight source.

29. An active matrix organic light-emitting device (OLED)-based display driven by single crystalline Si TFTs in a single crystalline Si layer a transmissive substrate.

30. An active matrix liquid crystal device (LCD)-based display driven by single crystalline Si TFTs in a single crystalline Si layer bonded to a transmissive substrate.

31. A method for forming a multilayer structure for an active matrix display, the method comprising:
forming a single crystalline Si-coated substrate by bonding a single crystalline Si layer to a light-transmissive substrate;
forming a light-emitting device over the single crystalline Si-coated substrate.

32. The method of claim 31 wherein forming a single crystalline Si-coated substrate comprises:
wafer bonding a single crystalline Si wafer to the light-transmissive substrate;
removing a portion of the single crystalline Si wafer after wafer bonding.

33. The method of claim 32 wherein removing the portion of the single crystalline Si wafer comprises performing at least one of etch-stopping, localized polishing, and ion cutting.

34. The method of claim 32 wherein wafer bonding comprises:
implanting the single crystalline wafer with hydrogen ions;
treating the single crystalline wafer and the light-transmissive substrate with oxygen plasma;
bonding the single crystalline wafer and the light-transmissive substrate.

35. The method of claim 34 wherein the single crystalline wafer and the light-transmissive substrate are bonded at or about room temperature after treating.

36. The method of claim 35 wherein wafer bonding further comprises:
heating the single crystalline wafer and light-transmissive substrate after bonding to an elevated temperature to strengthen bonding.

37. The method of claim 36 wherein removing the portion of the single crystalline wafer comprises:
raising the single crystalline wafer and the light-transmissive substrate after bonding to a more elevated temperature to delaminate the single crystalline wafer.

38. The method of claim 37 wherein removing the portion of the single crystalline wafer further comprises:
dry etching the bonded single crystalline wafer and light-transmissive substrate after delaminating the single crystalline wafer.

39. The method of claim 38 wherein dry etching is performed in a mixture of CF₄ and O₂.

40. The method of claim 31 further comprising:
forming a buffer layer between the light-transmissive substrate and the light-emitting device.

41. The method of claim 31 wherein forming a light-emitting device comprises forming at least one of an organic light-emitting device (OLED), a polymer light-emitting device (PLED), and a liquid crystal device (LCD).

42. The method of claim 31 wherein forming a light-emitting device comprises:
depositing a hole injector over the single crystalline Si-coated substrate;
depositing a hole-transporting layer over the hole injector;
depositing an electron-transmitting layer;
depositing a light-emitting layer;
depositing a electron injector layer.

43. The method of claim 31 wherein forming a light-emitting device comprises:
forming a rear polarizer over the single crystalline Si-coated substrate;
forming a light-transmissive electrode over the rear polarizer;
forming a polymer alignment layer over the light-transmissive electrode;
forming a layer of liquid crystal molecules over the polymer alignment layer;
forming another polymer alignment layer over the layer of liquid crystal molecules;
forming another light-transmissive electrode over the another polymer alignment layer;
forming a front polarizer over the another light-transmissive electrode;
forming a backlight source over the front polarizer.
